(19) United States
(12) Patent Application Publication
(10) Pub. No.: US 2008/0046098 A1
(43) Pub. Date: Feb. 21, 2008

(54) COMBINED MEDIA PLAYER AND COMPUTER CONTROLLER

(75) Inventors: James Corbin, Providence, RI (US); Gregor Mittersinker, Warwick, RI (US); Christopher Roman, Wrentham, MA (US); Michael Leighton, Sun Prairie, WI (US); Jacob Sigal, Blacklick, OH (US); Brad Rhodes, Cranston, RI (US); Josh Burkett, Sherman Oaks, CA (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/691,589

(22) Filed: Mar. 27, 2007

Related U.S. Application Data
(60) Provisional application No. 60/743,877, filed on Mar. 28, 2006.

(51) Int. Cl. G05B 15/00

(52) U.S. Cl. 700/1

(57) ABSTRACT

A combined computer media player and computer controller is disclosed. The apparatus includes a main housing with media controls thereon and a processor therein. An input port for connecting a mass storage device to the processor so the processor has access to media files thereon. An optical disc reader located in the housing and connected to the processor so the processor has access to media files thereon. The media files are playable, controllable, mixable and modifiable by the media controls. The apparatus further includes media output ports on the main housing that are connected to the processor to output a media files for listening or viewing. An input port for connecting the apparatus to a computer is included so the apparatus can control software running thereon.

### CROSS-REFERENCE TO RELATED APPLICATION

This application claims priority to earlier filed U.S. Provisional Application Ser. No. 60/743,877, filed Mar. 28, 2006, the contents of which are incorporated herein by reference.

### BACKGROUND OF THE INVENTION

1. Field of the Invention

The present invention relates to media players and controllers for controlling other devices, namely, computers and software loaded thereon. In particular, the present invention relates to a combined media player and computer controller devices that can operate in various modes depending on the needs of the user.

2. Background of the Related Art

In the prior art, it is well known to play back and control media files, such a audio and video files, using various devices. For example, such media may be played back in an analog fashion where a turntable or VCR is used. However, today, such media files are typically stored and played back in digital form. The disclosure will be addressed in connection with audio files, however, it should be understood that the present invention can be employed to play back video files with the appropriate modifications.

Digital files are commonly stored on optical media (e.g. CDs); hard drives, RAM and other digital media. Users, particularly disc jockeys have particular needs as to how these files can be managed and played back. Most importantly, disc jockeys need flexibility in how these files can be played back and managed.

In view of the foregoing, there is a need for a media player and controller than can play back and manage digital files in any form. There is a need for a media device that can access, play and modify (e.g. digitally scratch) digital files stored on optical discs. There is a need for a media device that can access, play and modify (e.g. digitally scratch) digital files stored on mass storage class devices, such as external hard drives, RAM devices and portable media players that can function in a mass storage class device mode. There is a further need for a media device that can access, play and modify (e.g. digitally scratch) digital files stored on a computer connected thereto as well as control software on a computer that controls media thereon.

### SUMMARY OF THE INVENTION

The apparatus of the present invention provides a new and novel combined media player and computer controller that is more flexible and functional than prior art devices. Moreover, the apparatus the present invention includes the ability to modify the played back signal, such as by mixing, equalization and digital scratching and others.

First, the apparatus of the present invention can play back optical discs (CDs). A slot is provided for receipt thereof where an internal CD player is provided that can read audio CDs as well as data CDs with encoded files thereon, such as mp3, wma, aac and ogg, for example. The detailed description includes additional details concerning full control and playback of audio read from optical CDs. The large central wheel can be used for control and scratching of the played back signal. A full feature set of controls are discussed in detail in the detailed description.

Second, a mass storage class device, such as an external hard drive or portable media player, operating in mass storage class mode, can be connected to the apparatus so that the apparatus can gain access to media files stored on the attached mass storage class device. In this case, the apparatus, similar to above, can playback, modify and manage files thereon, including digital scratching thereof, mixing and sound enhancement.

Still further, the apparatus of the present invention can operate as a controller for another device. For example, the apparatus can operate as a MIDI controller to control software on a computer, such as a PC, via a USB, IEEE-1394 or other interconnection with the appropriate PC drivers. MIDI control data can be sent by these protocols directly to the I/O subsystem of the PC for use by software running thereon. When used in this mode, the apparatus can replace keyboard and mouse actions on the PC for a given software application running thereon. For example, a disc jockey or digital audio workstation (DAW) software application may be running on the PC that plays back, manages and modifies media files. Many of these software applications include transport control and the ability to digitally scratch files available on the computer or on a storage device connected thereto. As a example, the central wheel can be used to digitally scratch a media file that is being controlled by the DAW. Such operation is virtually impossible to carry out effectively with a mouse or keyboard. Also, there may be a desire to control cue location in a given track loaded into a DAW application. The central control wheel of the apparatus of the present invention can be employed to easily move the cue or current time point in the current track. This is an alternative to using a mouse or keyboard which is awkward for this purpose.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the preferred embodiment of the apparatus of the present invention;

FIG. 2 is top view thereof;

FIG. 3 is a front view thereof; and

FIG. 4 is a rear view thereof.

### DESCRIPTION OF THE PREFERRED EMBODIMENT

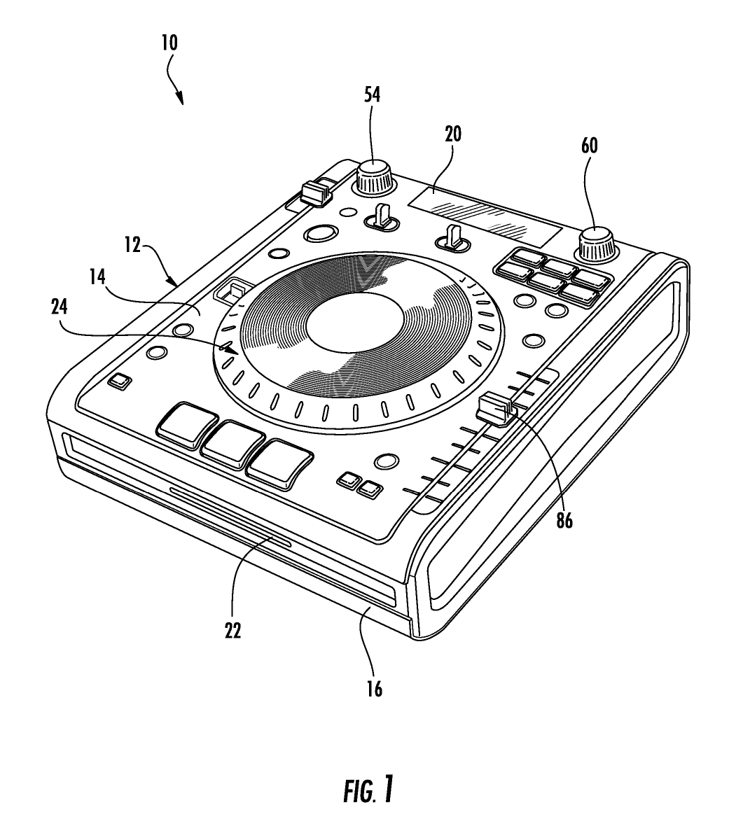

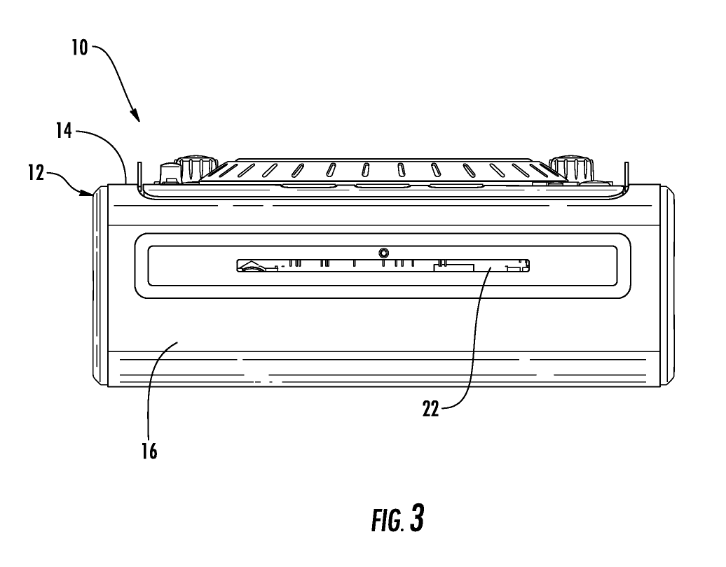

Referring to FIG. 1, a preferred embodiment of the combined media player and computer controller of the present invention is generally shown at 10. The combined media player and computer controller 10 of the present invention includes a housing 12 having a top surface 14, a front panel 16 and a rear panel 18. The top surface 14 of the housing 12 generally includes all of the controls for operating the combined media player 10 and the display screen 20. On the rear panel 18, the combined media panel includes all of the various input and output connectors to enable the combined media player 10 to be connected to a personal computer and other disc jockey audio and visual devices (not shown). The front panel 16 of the combined media player 10, best seen in FIG. 3, preferably includes a slot-loading optical drive 22 for optical media such as CD or DVD discs.

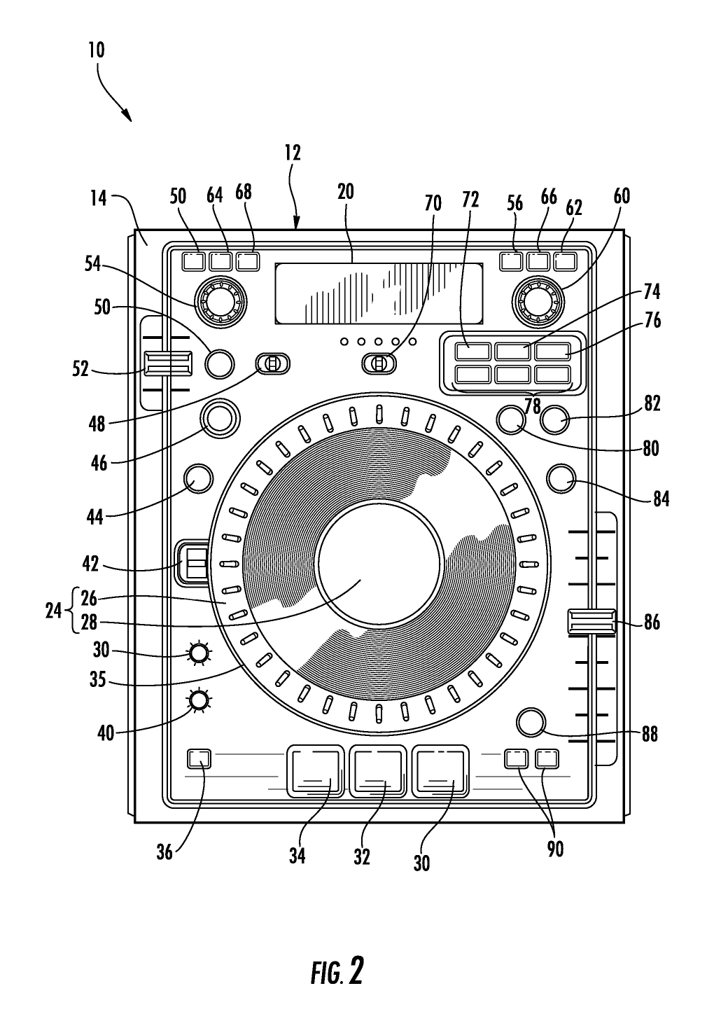

Referring now to FIG. 2, on the top surface 14 of the housing 12 of the combined media player 10 is an LCD display 20, which displays all the status information and functions related to the operation of the combined media player 10. For example, CD text (if available), ID3 tag information and effects settings are all shown here.

Located prominently in roughly the center of the top surface of the housing is a large jog wheel 24. The jog wheel 24 includes an inner portion 26 and an outer portion 28 that are separately movable from one another. The inner portion 26 of the wheel 24 can be used for scratching, cueing and searching through media tracks. The outer portion 28 of the wheel 24 can be used to apply a temporary pitch bend effect to a selected media track.

Adjacent to the jog wheel 24 is a play control 30. The play control 30 invokes the combined media player 10 to start playing a selected media track. Upon activation of the play control 30, the media track will begin playing from either the cue point or the last point of pause. Activating the play control 30 while the combined media player 10 is playing will restart the media track from the last set cue point, which can be used to create a “stutter” effect.

Further included is a pause control 32. The pause control 32 stops a playing media track while in play. Activating the play control 30 following activation of the pause control 32 sets a new cue point. Activating and holding the pause control 32 while using the jog wheel 24 to apply a scratch or stuttering effect to the media track stops the media track at the current position, allowing the disc jockey to capture a loop in or cue point.

Further included is a cue control 34. The cue control 34 returns and pauses the media track at the last set cue point. The cue point is the last place in which the combined media player 10 was paused and then the play control 30 was activated. Activating the cue control 34 a second time allows for temporary play of this point. The disc jockey can easily edit the cue point by using the jog wheel 24. As the disc jockey rotates the jog wheel 24 the media track plays. By stopping the jog wheel 24 and activating the play control 30, a new cue point is set. The jog wheel 24 is encircled by a ring of LEDs 25 that can light in various patterns depending on the function of the jog wheel 24 and the beat of the media track currently playing.

Further included is an eject control 36. Activating the eject control 36 ejects the optical media, if any, currently loaded in the optical drive 22. If a media track on the optical media is currently being played by the media player, this control 36 has no effect. If the combined media player 10 is currently in USB Master Mode, described further below, activating the eject control 36 allows the disc jockey to safely remove a USB device (not shown) connected to one of the USB ports 92.

Further included is a brake adjust knob 38 and a start time adjust knob 40. These knobs 38, 40 are used to adjust the speed that the media track starts play when the play control 30 is activated or the speed that the media track stops when the pause control 32 is activated, respectively.

Further included is a bleep/reverse switch 42. The bleep/reverse switch 42 allows the combined media player 10 to play a media track backwards in one of two modes; “bleep” mode and a reverse mode. In “bleep” mode, the media track will play in reverse while the media continues to advance normally. When the disc jockey releases the switch 42, the media track continues to play where it would have been if the disc jockey had not engaged the switch. In “reverse” mode, the media track plays in true reverse. After the disc jockey release the switch 42 the media track resumes forward play from where the “reverse” mode play ended.

Further included is a scratch control 44. The scratch control 44 turns scratch mode on or off, respectively. If scratch mode is on, the scratch control 44 will light up and the inner portion 28 of the jog wheel 24 will allow the disc jockey to apply a scratch-like effect to the media track as if it were a turntable when the inner portion 28 of jog wheel 24 is rotated. If scratch mode is off, the inner portion 28 of the jog wheel 24 functions as a pitch bend when it is rotated.

Further included is a tap control 46. Activating the tap control 46 in time with the beat of the media track aids a built in beats per minute (“BPM”) counter detect the proper tempo of the media track. Activating and holding the tap control 46 for approximately two seconds causes the BPM counter to reset and recalculate.

Further included is an F/X selector switch 48. This toggle switch 48 is used to choose from a variety of pre-programmed effects to apply to a media track, which are further described further below.

Further included is an F/X control 50. Activating the F/X control 50 turns effect mode of the F/X selector switch 48 on or off. If the F/X control 50 is illuminated, effects mode is on.

Further included is a wet/dry fader control 52. The wet/dry fader control 52 adjusts how much of an effect is mixed into the final mix of the media track that is routed through the outputs. The 0% or “dry” side of the fader control allows less of the effected media track and more of the original media track, while the 100% or “wet” side of the fader control adds more of the effected media track and less of the original media track to the final mix.

Working in conjunction with the F/X control 50 and F/X selector switch 48 is a parameter knob 54. The parameter knob 54 has multiple effects depending upon the settings of the F/X selector switch 48 and F/X control 50. By default, turning the parameter knob 54 adjusts a parameter of the effect currently selected with the F/X selector switch 48. The F/X selector switch 48 is used to choose a desired effect. The F/X control 50 activates and deactivates the F/X selector switch 48. The wet/dry fader control 52 is used to adjust the effect presence in the mix. Most effects can by synched to a ratio of the BPM counter by holding down the parameter knob 54 while turning it, or controlled manually by turning the parameter knob 54 without holding it down.

There are six special effects available. The first effect is an isolation (band pass) filter that lets you play only a specific frequency of the music. Rotation of the parameter knob 54 moves the filter frequency. Pressing down on the parameter knob 54 while turning it performs a coarse adjustment to the frequency. Just turning the parameter knob 54 without holding it down performs a fine adjustment of the filter frequency.

The second special effect is an echo, which creates a reverb effect. The rate of the echo can be adjusted with the parameter knob 54. Holding down the parameter knob 54 while turning will allow you to synch the effect to a ratio of the BPM counter.

The third special effect is a chop, which simulates turning a mute button on and off in time with the music. The speed of the effect is controlled by turning the parameter knob 54 and can also be synched to a ratio of the BPM counter by pressing down on the parameter knob 54 while turning it.

The fourth special effect is a pan, which alternates playing the right then left speaker channel based on either the tempo of the BPM counter or the speed selected manually. To set the rate, turn the parameter knob 54. Synchronizing the speed of the effect to a ratio of the BPM counter can be accomplished by pressing down on the parameter knob 54 while turning it.

The fifth special effect is a phaser, which applies a sweeping phase shifter effect to the media track. It is similar to the flanger effect, described below, except that the phaser is enharmonic, and has a more “swooshing” sound. The speed of the effect is controlled turning by the parameter knob 54 and can also be synched to a ratio of the BPM counter by pressing down on the knob 54 while turning it.

The sixth special effect is a flanger, which causes a sweeping effect with a more pronounced harmonic sound than the phaser, reminiscent of a jet engine passing overhead. The speed of the effect is controlled turning by the parameter knob 54 and can also be synched to a ratio of the BPM counter by pressing down on the knob 54 while turning it. Other settings can be adjusted by holding down an appropriate button while turning the parameter knob 54.

Further included is a time control 56. The time control 56 toggles the display 20 to show elapsed time, time remaining on the current media track, or time remaining of the entire play order.

Further included is a program control 58. The program control 58 is used to specify the play order or “program” of the current media loaded in the optical drive 22. Activating the program control 58 enters program mode. The disc jockey can then manipulate a track selection knob 60 to choose the first song for the program. The program control 58 is activated again to store that media. These steps are repeated in the same manner to assemble a complete program. Activating the play control 30 begins playing the selected media tracks, in the order you chosen for the program. Activating and holding the program control 58 while turning the parameter knob 54 invokes a list of menu options.

The first option is a Next Track Fade Time option that includes five user-selectable settings (On, Off, 1s, 2s, 3s). This option allows the disc jockey to automatically fade from one media track to the next. After turning this option on, the disc jockey is prompted to enter the desired fade time from about 1 to 3 seconds using the parameter select knob 54.

The second option is a Scratch Delay option, which activates a slight or momentary delay to applying the scratch effect to the media track when releasing the jog wheel 24 in scratch mode.

The third option is a Remote Start option, which enables the combined media player 10 to be started by another device using a remote start cable (not shown).

The fourth option is a Power-On Play option, which causes the optical disc player 22 to begin playing as soon as the power is turned on to the combined media player 10.

The fifth option is a Memo All Clear option, which clears all stored cue points and loop point information previously stored or set.

The sixth option is a Sleep Mode, which, when engaged, puts the combined media player 10 into a “sleep” state after approximately a few minutes of inactivity.

The seventh option is a Preset Clear, which resets all global parameters to their default settings.

The firmware version number may also be displayed by pressing the parameter knob 54 while simultaneously activating and holding the program control 58 as an eight option.

The ninth option is a Power-On Demo, which, when this option is on, the combined media player operates in a “demo mode” where the jog wheel LEDs 25 illuminate in a pattern as soon as the unit is powered on.

Further included is a source control 62. The source for media tracks may be selected by activating and holding source control 60 while simultaneously turning the parameter knob 54 to choose an input source. In particular, the optical disc drive 22, an optional device connected to the USB ports 92, or the combined media player 10 can be put in a computer controller mode, described further below. However, the source control 62 does not function if the combined media player 10 is currently playing a media track.

Further included is a recall/restore control 64. Activating and holding the recall/restore control 64 for about two seconds allow cue points to be stored for media tracks of a particular optical disc. More than one cue set can be stored per optical disc. Cue sets are numbered sequentially per optical disc. When an optical disc with stored cue points is inserted, the display will indicate that there are preset “Cue Points Available”. To recall stored cue points, the disc jockey activates the recall/restore control 64. If more than one set of cue points has been saved for a particular optical disc, the disc jockey may use the parameter knob 54 to cycle through the stored cue sets and select the desired cue set.

Further included is a back control 66. When navigating an optical disc loaded in the optical disc drive 22 or a storage device connected to one of the USB ports 92 that include a file system organized with folders, the back control 66 enables the disc jockey to navigate back and up to the previous level (or folder).

Further included is a play mode control 68. The play mode control 68 sets one of four playback modes. Single mode plays the selected media track, then pauses and cues the next track. Single/Replay mode repeats the current song until manually stopped. Random mode plays all media tracks on an optical disc loaded in the optical disc drive 22 in a random order. Continuous play mode plays all songs on an optical disc loaded in the optical disc drive 22 in order then repeats play from the beginning.

Further included is a track select knob 60. The track select knob 60 is used to skip from media track to media track and for folder navigation and as an “enter” button.

Further included is a shift control 70. The shift control 70 is used with the looping features of the combined media player 10, described further below. The shift control 70 allows the disc jockey to cut a loop in half or double it. If the smart loop feature is on, a minimum length of one beat is required, however.

A set of loop controls is further included. In particular, a loop in control 72, a loop out control 74 and a reloop control 76 is provided. These buttons 72, 74, 76 are used to define the beginning and ending loop points (Loop In and Loop Out) or to replay or restart a previously defined loop (Reloop).

By default, a “loop in” point is automatically set at the beginning of the media track. To define a new “loop in” point within a media track, activate the loop in control 72 when the media track reaches the desired point. An indicator in the loop in control 72 will light, indicating a new “loop in” point has been set. An indicator in the reloop control 76 will also illuminate, indicating that the disc jockey may also activate it to immediately go back to the “loop in” point. A loop in point may be changed by activating the loop in control 72 again.

Activating the loop out control 74 for first time while a media track is playing, causes an indicator in the loop out control 74 to blink and the combined media player 10 to play the media track in a seamless loop, starting from the “loop in” point and ending at the “loop out” point. To release, or end the loop, the loop out control 74 may be activated a second time. Play resumes forward when the media track passes the previously set loop out point. The indicator in the loop out control 74 remains continuously lit, indicating that the loop is now in memory for re-looping purposes.

Activating the reloop control 76 repeats play or “stutters” (if repeatedly tapped) from the loop in point. If a loop has previously been set, it plays and repeats that loop, until the loop is released by activating the loop out control 74.

Further included are a set of three trigger buttons 78. These buttons 78 are used for three user-selectable modes, chosen by holding the record button 80 and turning the parameter knob 54. Additionally, the record button 80 is used in conjunction with the three assignable trigger buttons to record samples and set hot start points. By pressing the mode button 82, the desired mode for the three trigger buttons 78 can also be changed. In particular, the modes may be cycled between LOOP-2, HOT CUE and SAMPLES.

In LOOP-2 mode the three trigger buttons 78 act as another set of loop buttons that behave in the same way as the loop controls described previously above. This gives the disc jockey the ability to set two completely separate sets of loop points.

In HOT CUE mode, up to three “hot cue points” may be set, one for each trigger button 78, respectively. These are similar to regular cue points, except that when the trigger buttons 78 are pressed, the combined media player 10 instantly jumps to the defined hot cue point and begins play.

To define a hot cue point, activate the record button 80 to arm recording, then press the desired trigger button 78. The combined media player 10 records the media track from that point onward and assigns it to a memory buffer connected that that specific trigger button 78. To end recording and instantly start playing from the hot cue point, the disc jockey merely presses the same trigger button 78 again.

In SAMPLE mode, an audio sample up to about five seconds long may be recorded on each of the three trigger buttons 78.

To record a sample, press and release record button 80 to arm recording and then press one of the three trigger buttons 78. The combined media player 10 then begins recording until either the selected trigger button 78 is pressed again to stop recording or the buffer runs out of sample space.

To play back the sample, the appropriate trigger button 78 is pressed. Buttons 78 with samples assigned to them have a lit indicator, whereas with unassigned trigger buttons 78 the indicators while remain dark.

There are also three playback options you can choose for each of the three sample trigger buttons 78. To choose a mode, the disc jockey presses and holds the record button 80 and the desired trigger button 78, while simultaneously turning the parameter knob 54 to select the desired option. To modify the selected option, the disc jockey presses down and releases the parameter knob 54 then turns the parameter knob 54 to the desired setting. Pressing down on the parameter knob 54 again, locks in that option choice.

The first sample option is Sample Insert, which determines whether the sample will override the currently playing media track source or if it will be mixed together with the currently playing media track source. With the Sample Insert option ‘On’, the sample will override the playing media track, and while ‘Off’, the sample will be mixed in with the playing media track.

The second option is Sample Reverse, which when on, plays the sample in reverse.

The third option is Mix Value, which includes setting of 0-100. This setting controls the volume of the sample when played back.

Further includes is a search control 84. When engaged, the combined media player 10 is placed in search mode, which allows the inner portion 28 of the jog wheel 24 be used to quickly scan through the current track. If the jog wheel 24 is not touched for about ten seconds, search mode will automatically exit. Search speed can be adjusted by activating and holding the search control 84 and turning the parameter knob 54.

Further included is a pitch fader 86, which is used to control the speed of the media track. Moving the pitch fader 86 towards the “+” speeds the tempo of the media track up, while moving towards the “−” slows it down. The percentage of pitch adjustment is shown on the display 20.

Further included is a pitch/keylock button 88. The pitch/keylock button 88 controls the range of the pitch fader 86 as well as enabling and disabling key lock mode. Pressing and releasing the pitch/keylock button 88 to cycles through pitch fader 86 settings of +/−6%, 12%, 25% and 100%. The pitch fader 86 may be disabled by pressing the pitch/keylock button 88 again after selecting 100%, which effectively sets it to 0%. To engage key lock mode, the pitch/keylock button 88 is held for about two seconds. This feature allows the speed of the media track to be changed without changing the key. The key of the media track locks to whatever position the pitch fader 86 was set at when key lock was engaged. The key of a media track may be manually changed by pressing and holding holding the pitch/keylock button 88 while turning the parameter knob 54.

Further included is a pair of pitch bend buttons 90, which allows brief adjustments to the speed of the media track, faster or slower, for as long as the up or down button 90 is held, respectively. The pitch bend buttons 90 are useful for quick speed adjustments to help match the beats of two media tracks that might be at the same tempo but have beats that hit at slightly different times.

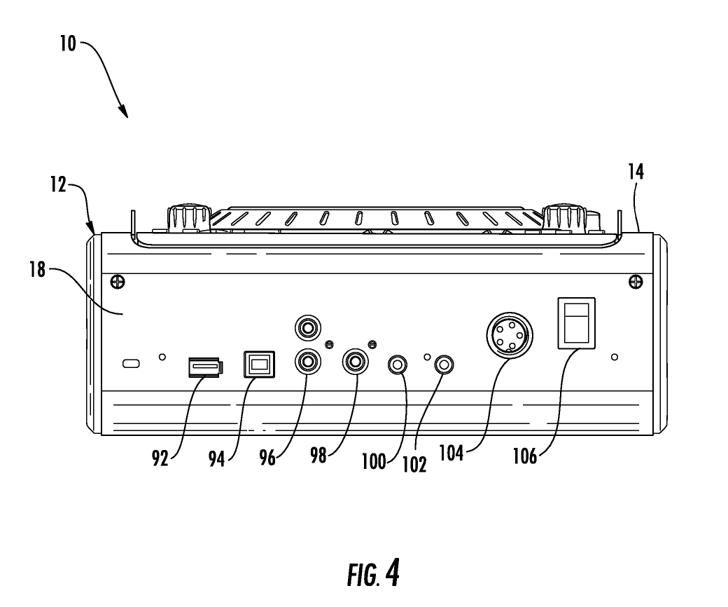

Turning now to the rear panel 18 of the combined media player 10 shown in FIG. 4, a USB input port 92 is further included. The USB input port 92 permits USB storage devices (not shown) to be connected to the combined media player 10 to read and play back additionally media files stored on these optional USB storage devices. These optional devices could be external hard disc drives, additional removable media drives, and portable/personal media playing devices.

Further included is a USB slave port 94, which allows the combined media player to be connected to a personal computer (not shown). The combined media player 10 can be used as a USB controller device using the USB Human Interface Device protocol. However, this port could also be configured as a standard serial port and implement the MIDI protocol also.

Further included is an output port 96. The output port 96 is preferable a pair of RCA jack to permit the combined media player 10 to be connected to a speaker system or to any device that is designed to accept an RCA line level connection.

Further included is a digital output port 98. The digital output port 98 is preferably also an RCA type connector to allow a digital signal to be sent to a device designed to accept a S/PDIF (Sony/Phillips Digital Interface Format) signal. The digital output port 98 may also be connected to a karaoke decoder to reproduce the graphics from CD+G compatible discs.

Further included is a fader start connector 100. This connector 100 is used to plug into a fader-start compatible mixer or remote switch. Every time the crossfader on a fader start compatible mixer is moved to the side that the combined media player 10 is on, it will start playing. When the fader is moved away from that side, the combined media player 10 stops playing. Foot switches can also be attached to this connector 100 for creative mixing techniques. There are two types of footswitches that will work with the combined media player 10. The first is a typical on/off pushbutton switch and is generally used for switching channels on a guitar amplifier. The second type is a momentary footswitch commonly used as a keyboard sustain pedal.

Further included is a relay connector 102, which allows two compatible media players 10 to alternate play from one unit to the other and back as the media tracks end on each respective player 10. Relay mode may be turned on and off by holding the mode button 68 and turning the parameter knob 54 to the desired setting.

The rear panel 18 also includes a standard power plug connector 104 and a power button 106 to turn the combined media player 10 on and off.

It should be understood that the various connectors, knobs, buttons and sliders are indicated. However, these are preferred configurations and other configurations are contemplated by the present invention. For example, USB connections are preferred but it is possible to employ IEEE-1394 (also known as Firewire or iLink) connections. Similarly, RCA connectors are preferred, however, optical connections, for example, may be used. While sliders are preferred for fading, such operation can be carried out by knobs.

All of the controls are centrally operated by a central internal microprocessor. The microprocessor resides in the housing 12 and handles processing of media files. The controls on the top surface 14 of the housing of the combined media player 10 are electrically interconnected to the microprocessor. Similarly, the microprocessor is electrically connected to and controls the internal optical drive 22. A media storage device or devices (if multiple ones are connected) are also electrically interconnected to the microprocessor through the USB ports 92 or other interconnections provided for on the rear panel 18 of the housing 12.

Therefore, it can be seen that the present invention provides a unique solution to the problem of providing a combined media player and computer controller for a disc jockey that is easy to operate by a disc jockey and includes many of the controls and features that disc jockeys have become accustomed to and rely upon when performing.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A combined computer media player and computer controller, comprising:
a main housing with media controls thereon;
a processor;
an input port for connecting a mass storage device to the processor in the main housing so the processor has access to media files thereon;
an optical disc reader located in the housing and connected to the processor so the processor has access to media files thereon;
the media files being playable, controllable, mixable and modifiable by the media controls;
media output ports on the main housing and connected to the processor to output a media files for listening or viewing; and
an input port for connecting the apparatus to a computer so the apparatus can control software running thereon.

2. The apparatus of claim 1, further comprising:
a jog wheel having an inner portion and an outer portion for applying a digital effect to said media files;
said inner portion being separately rotatable from said outer portion; and
said outer portion being separately rotatable from said inner portion

3. The apparatus of claim 2, wherein said digital effect is selected from the group comprising: cueing, scratching, searching, and pitch bend.

4. The apparatus of claim 1, further comprising a display having a plurality of indicia indicating the status and operation of said apparatus.

5. The apparatus of claim 1, wherein said input port is a USB port and the apparatus connects to a computer via the USB Human Interface Device Protocol.

6. The apparatus of claim 1, wherein said input port is a serial port and the apparatus connects to a computer via the MIDI protocol.

7. The apparatus of claim 1, further comprising:
a special effects selector for applying a digital effect to the media files selected for output through the media output ports.

8. The apparatus of claim 7, wherein said digital effect is selected from the group comprising: isolation filter, echo, chop, pan, phaser, and flanger.

9. The apparatus of claim 1, further comprising:
a plurality of user-settable trigger buttons for looping, setting additional hot cue points, and recording and playing back media samples.

10. The apparatus of claim 9, wherein there are three user-settable trigger buttons.

11. A combined computer media player and computer controller, comprising:
a main housing with media controls thereon;
a processor;
an input port for connecting a mass storage device to the processor in the main housing so the processor has access to media files thereon;
an optical disc reader located in the housing and connected to the processor so the processor has access to media files thereon;
the media files being playable, controllable, mixable and modifiable by the media controls;
the media controls including a jog wheel for applying a digital effect to the media files, a special effects selector for applying a digital effect to the media files, and a plurality of user-settable trigger buttons for looping, setting additional hot cue points, and recording and playing back media samples;
media output ports on the main housing and connected to the processor to output a media files for listening or viewing; and
an input port for connecting the apparatus to a computer so the apparatus can control software running thereon via the USB Human Interface Device Protocol.

12. The apparatus of claim 11, wherein the jog wheel includes an inner portion and an outer portion;
said inner portion being separately rotatable from said outer portion; and
said outer portion being separately rotatable from said inner portion

13. The apparatus of claim 12, wherein said digital effect is selected from the group comprising: cueing, scratching, searching, and pitch bend.

14. The apparatus of claim 11, further comprising a display having a plurality of indicia indicating the status and operation of said apparatus.

15. The apparatus of claim 11, wherein said digital effect is selected from the group comprising: isolation filter, echo, chop, pan, phaser, and flanger.

16. The apparatus of claim 11, wherein there are three user-settable trigger buttons.
